(19) United States
(12) Patent Application Publication
(10) Pub. No.: US 2018/0068423 A1
(43) Pub. Date: Mar. 8, 2018

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Keiji Adachi, Kawasaki-shi (JP)

(21) Appl. No.: 15/696,609

(22) Filed: Sep. 6, 2017

(30) Foreign Application Priority Data
Sep. 8, 2016 (JP) 2016-175223

(51) Int. Cl. G06T 5/00; G06T 7/11; G06K 9/00; G06K 9/20

(52) U.S. Cl. CPC G06T 5/002; G06T 7/11; G06T 2207/30196; G06K 9/2054; G06K 9/00369

(57) ABSTRACT

An image processing apparatus includes a processing unit that generates a first image in which blurring processing for protecting privacy is executed with respect to a specific region in an image specified by image analysis, a first output unit that outputs the first image generated by the processing unit to a first output destination, and a second output unit that outputs a second image including at least a part of an image of the specific region before the blurring processing is executed by the processing unit to a second output destination different from the first output destination.

### BACKGROUND

### Field

The present disclosure relates to an image processing apparatus, an image processing method, and a storage medium.

### Description of the Related Art

Monitoring cameras have become popular in recent years. As a result, appearance of an individual included in an image (video image) captured by a monitoring camera in a public space can easily be viewed by other people, which can become a privacy issue.

Therefore, there is provided a technique for protecting privacy of an object in an image captured by a camera. In the technique described in Japanese Patent Application Laid-Open No. 2008-191884, a portion of an object image in a captured image is extracted and an image in which image processing (shading processing) for protecting privacy is executed on the extracted portion of the object image is output to an image display apparatus, such as a monitor.

### SUMMARY

According to an aspect of the present invention, an image processing apparatus according to the present invention includes a processing unit configured to generate a first image in which blurring processing for protecting privacy is executed with respect to a specific region in an image specified by image analysis, a first output unit configured to output the first image generated by the processing unit to a first output destination, and a second output unit configured to output a second image including at least a part of an image of the specific region before the blurring processing is executed by the processing unit to a second output destination different from the first output destination.

Further features will become apparent from the following description of exemplary embodiments with reference to the attached drawings.

### BRIEF DESCRIPTION OF THE DRAWINGS

FIG. 1 is a diagram illustrating a configuration of network connection as one example of an image processing system.

FIG. 2 is a diagram illustrating an example of a hardware configuration of an imaging apparatus.

FIG. 3 is a functional block diagram of an image processing apparatus.

FIG. 4 is a diagram illustrating a flow of image processing executed by the image processing apparatus.

FIG. 5 is a diagram illustrating output destinations of an unprocessed image and a processed image.

FIG. 6 is a flowchart illustrating an operation of the image processing apparatus.

### DESCRIPTION OF THE EMBODIMENTS

Hereinafter, an exemplary embodiment will be described with reference to the appended drawings.

The exemplary embodiments described below are merely examples and can be modified or changed as appropriate based on a configuration or various conditions of the apparatus to which the present disclosure is applied. The below-described exemplary embodiments are thus not seen to be limiting.

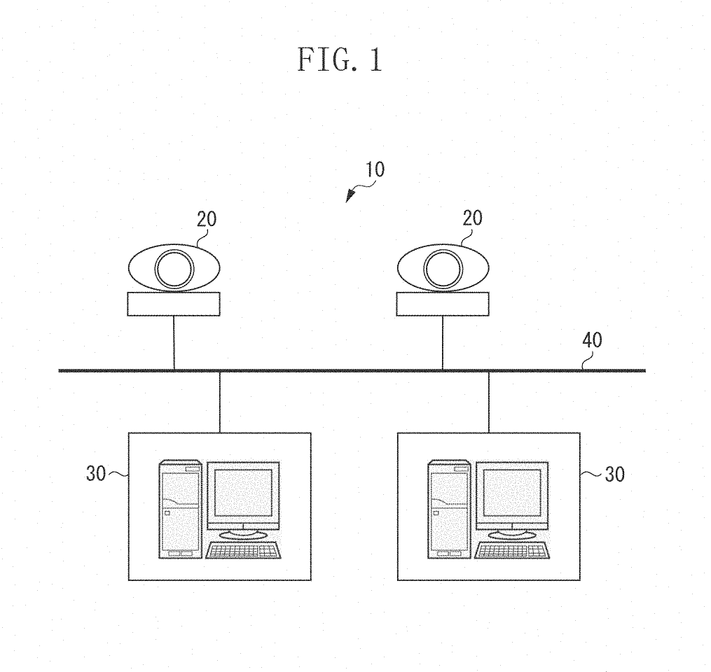

FIG. 1 is a diagram illustrating a configuration of network connection as one example of an operating environment of an image processing system in the present exemplary embodiment. In the present exemplary embodiment, the image processing system is applied to a network camera system.

A network camera system 10 includes at least one network camera 20 (hereinafter, simply referred to as “camera 20”) and at least one information processing apparatus 30. The camera 20 and the information processing apparatus 30 are connected to each other via a local area network (LAN) 40. The network is not limited to being a LAN, but can also be the Internet or a wide area network (WAN). A connection mode of the LAN 40 can be wired or wireless. In FIG. 1, while two cameras 20 and two information processing apparatuses 30 are connected to the LAN 40, the number of cameras and information processing apparatuses that can be connected to the network 40 is not limited to what is illustrated in FIG. 1.

The camera 20 is an imaging apparatus, such as a monitoring camera, which includes an optical function and captures an image of an object at a predetermined field of view. The camera 20 executes image analysis processing in which a specific object (e.g., a human face) conforming to a predetermined condition is detected from a captured image (hereinafter, simply referred to as “image”), and a region of the detected specific object in the image is extracted as a specific region. Here, the image analysis processing includes at least any one of moving object detection, human body detection, and face detection.

The camera 20 executes image processing on the specific region in the image based on a processing result of the image analysis processing. The camera 20 can transmit a processing result of the image processing to the information processing apparatus 30 via the LAN 40. The camera 20 also includes a function for changing an imaging setting, such as a focus or a field of view of the camera 20, based on communication executed external to the camera 20. The camera 20 can be a fish-eye camera or a multi-eye camera.

The information processing apparatus 30 can, for example, be a personal computer (PC) and can be operated by a user (e.g., observer). The information processing apparatus 30 includes a display control function for displaying images distributed from the camera 20 or a result of the image processing on a display unit (display). The information processing apparatus 30 can include a function of an input unit enabling a user to set parameters of the image analysis processing or the image processing executed by the camera 20.

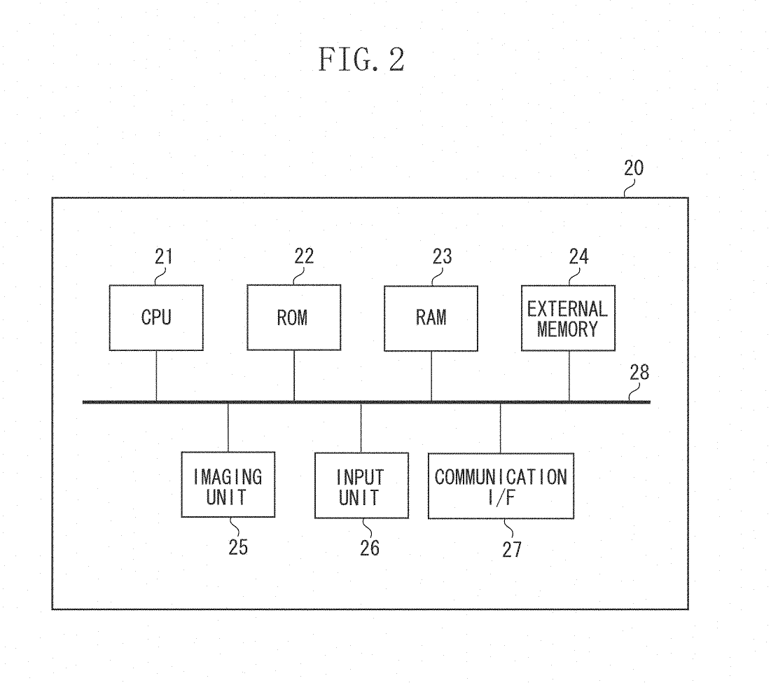

FIG. 2 is a block diagram illustrating an example of a hardware configuration of the camera 20.

The camera 20 includes a central processing unit (CPU) 21, a read only memory (ROM) 22, a random access memory (RAM) 23, an external memory 24, an imaging unit 25, an input unit 26, a communication interface (I/F) 27, and a system bus 28.

The CPU 21 controls operations executed by the camera 20, and controls respective components 22 to 27 via the system bus 28. The ROM 22 is a non-volatile memory for storing a control program necessary for the CPU 21 to execute processing. The control program can be stored in the external memory 24 or a detachable storage medium (not illustrated). The RAM 23 functions as a main memory or a work area of the CPU 21. When processing is to be executed, the CPU 21 loads a necessary program to the RAM 23 from the ROM 22, and executes the program to realize various functional operations.

The external memory 24 can store various kinds of data or information necessary for the CPU 21 to execute processing according to the program. The external memory 24 can store various kinds of data or information that the CPU 21 acquires by executing processing according to the program.

The imaging unit 25 captures an object image and includes, for example, an image sensor such as a complementary metal oxide semiconductor (CMOS) image sensor or a charge coupled device (CCD) image sensor. The input unit 26 includes a power button and various setting buttons, so that a user of the camera 20 can provide an instruction to the camera 20 via the input unit 26. The communication I/F 27 is an interface for communicating with an external apparatus, e.g., in the present exemplary embodiment, the information processing apparatus 30. The communication I/F 27 can be, for example, a LAN interface. The system bus 28 communicably connects the CPU 21, the ROM 22, the RAM 23, the external memory 24, the imaging unit 25, the input unit 26, and the communication I/F 27.

The information processing apparatus 30 includes a hardware configuration that includes a display unit or an input unit in place of the imaging unit 25. Here, the display unit includes a monitor, such as a liquid crystal display (LCD). An input unit includes a keyboard or a mouse that enables a user of the information processing apparatus 30 to provide an instruction to the information processing apparatus 30.

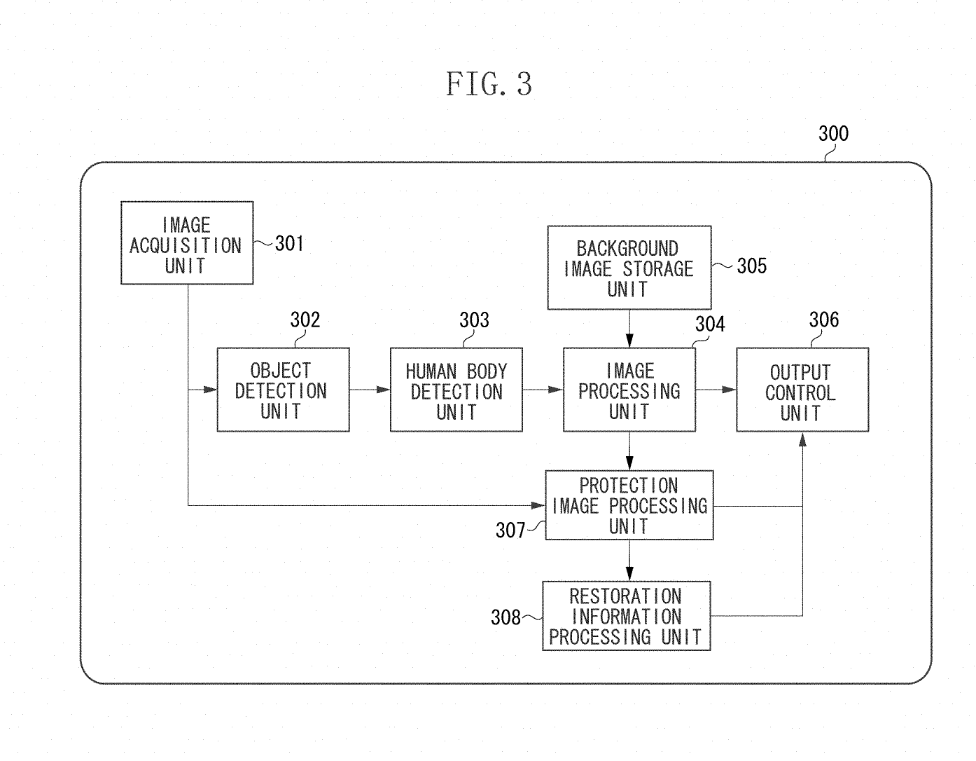

FIG. 3 is a block diagram illustrating a functional configuration of an image processing apparatus 300. The image processing apparatus 300 includes a function of executing the image analysis processing and the image processing described above, and displaying a processing result on a display screen of the information processing apparatus 30. In the present exemplary embodiment, while the camera 20 will be described as the image processing apparatus 300, a general PC different from the information processing apparatus 30 or another device can operate as the image processing apparatus 300.

The image processing apparatus 300 executes the image analysis processing for detecting a specific object as a target of privacy protection in the image and extracting a region of the detected specific object as a specific region where privacy protection should be executed. The image processing apparatus 300 executes image processing for generating a processed image (privacy protection processed image) in which image processing for protecting privacy is executed on the extracted specific region. Then, the image processing apparatus 300 outputs the generated processed image to the information processing apparatus 30. The image processing apparatus 300 outputs an unprocessed image (protection image) that includes at least a part of the image of the specific region before executing the image processing to an output destination different from the output destination of the processed image.

While the image processing apparatus 300 is described in the present exemplary embodiment, a video image processing apparatus is also applicable because the processing content is the same in that a video image is acquired and processed at each frame (image) of the video image.

The image processing apparatus 300 includes an image acquisition unit 301, an object detection unit 302, a human body detection unit 303, an image processing unit 304, a background image storage unit 305, an output control unit 306, a protection image processing unit 307, and a restoration information processing unit 308. In the present exemplary embodiment, the CPU 21 of the camera 20 executes a program to realize functions of respective units of the image processing apparatus 300 illustrated in FIG. 3. In addition, at least a part of the respective elements illustrated in FIG. 3 can be operated as dedicated hardware. In this case, the dedicated hardware is operated based on the control of the CPU 21 of the camera 20.

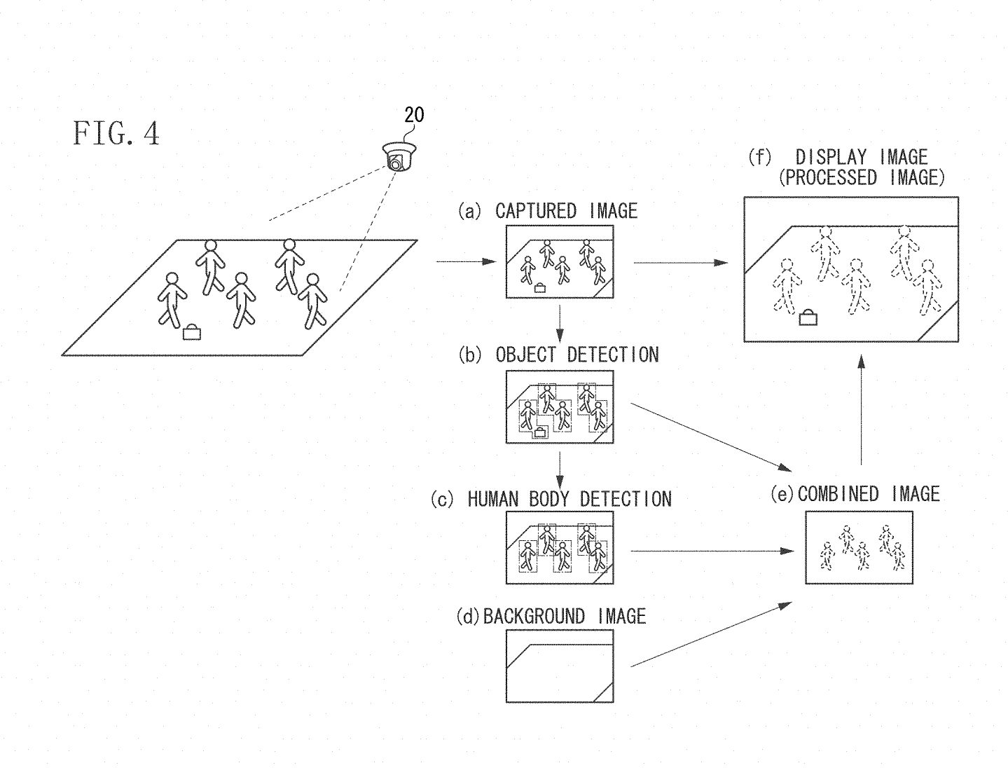

The image acquisition unit 301 acquires an image (i.e., a moving image or a still image) captured by the imaging unit 25 (see Image-A in FIG. 4). Then, the image acquisition unit 301 sequentially transmits the acquired image to the object detection unit 302. A supplying source of the image is not limited in particular, and the image acquisition unit 301 can acquire the image externally from the camera 20. The supplying source of the image can be a server apparatus or another imaging apparatus that supplies an image via wired or wireless communication.

The image acquisition unit 301 can acquire the image from a memory (e.g., external memory 24) of the image processing apparatus 300. In the below-described exemplary embodiment, it is assumed that the image acquisition unit 301 transmits a single image to the object detection unit 302 regardless of a case where the image acquisition unit 301 acquires a moving image or a still image. In the former case, the single image corresponds to each frame that constitutes the moving image, whereas in the latter case, the single image corresponds to a still image.

Based on the image acquired from the image acquisition unit 301, the object detection unit 302 detects an object in the image through a background differencing method (see Image-B in FIG. 4). Then, the object detection unit 302 outputs the information about the detected object to the human body detection unit 303. Here, the information about the detected object includes position information of the object in the image, information about a circumscribed rectangle of the object, and a size of the object. A region where object detection processing is executed by the object detection unit 302 (i.e., object detection processing region) can be set by the parameter provided from the ROM 22, the RAM 23, the external memory 24, or the communication I/F 27. The parameter can be set using a user interface of the information processing apparatus 30.

In the present exemplary embodiment, for the sake of simplicity, the region setting is not executed, and the entire region in the image is assumed as the object detection processing region. The object detection method is not limited to a specific method, such as the background differencing method, and any method can be employed as appropriate as long as the object in the image can be detected thereby.

The human body detection unit 303 uses a previously stored verification pattern dictionary to execute human body detection processing on a region in the image where the object is detected by the object detection unit 302 in order to detect a human body (see Image-C in FIG. 4). The human body detection method is not limited to pattern processing, and any method can be used as appropriate as long as the human body can be detected from the image.

A region where the human body detection processing is executed by the human body detection unit 303 (i.e., human body detection processing region) does not always need to be a region where the object is detected by the object detection unit 302. The human body detection unit 303 can execute the human body detection processing on just the human body detection processing region set by the above-described parameters. Alternatively, a maximum size and a minimum size of a human body as a detection target can be specified by parameter setting, so that the human body detection processing can be prevented from being executed when a size of the human body does not fall within the specified range. As described above, by setting limitations on a target of the human body detection processing, processing speed of human body detection can be accelerated.

While a human body is specified as the specific object in the present exemplary embodiment, the specific object is not limited to a human body. The specific object can be a human face, an automobile, an animal, etc. In a case where an object other than the human body is the specific object, a specific object detection unit for detecting a specific object is provided instead of the human body detection unit 303. In this case, a specific object detection unit for detecting various kinds of specific objects can be provided or detection processing of a plurality of specific objects can be executed if a plurality of pieces of detection can be simultaneously executed.

When the specific object is a human face, the human body detection unit 303 can execute face detection processing after executing the human body detection processing. In this case, the human body detection unit 303 detects a face by executing face detection processing on a human body region detected by the human body detection processing. For example, in the face detection processing, a feature portion of the human face can be detected by detecting an edge of the eye or the mouth from the human body region. In other words, in the face detection processing, a face region is detected based on a position, a size, and likelihood of the face. In the face detection processing, feature information used for personal authentication is extracted from the detected face region, and face authentication can be executed by comparing the extracted feature information with the previously stored dictionary data through pattern matching. An entire region in the image can be specified as the region for executing the face detection processing. In addition, when an object other than a human body is the specific object, feature amount detection processing for detecting a feature amount of the specific object (e.g., a license plate of an automobile) can be executed instead of the face detection processing.

From an object region detected by the object detection unit 302 and a human body region or a face region detected by the human body detection unit 303, the image processing unit 304 extracts a specific region where privacy protection should be executed. Then, as the image processing, the image processing unit 304 executes blurring processing for blurring the specific region in the captured image. Here, the specific region refers to an object image region where a person can be specified, e.g., a region that includes a face, clothes, or a manner of walking of a person. The image processing unit 304 can simply set the human body region detected by the human body detection unit 303 as the specific region, or can set an object region, a human body region, or a face region positioned within a predetermined region in the image as the specific region.

A region to be set as the specific region can be specified by the parameter setting. Therefore, in a case where the specific object is a human body, just a human body region, a face region, an upper body region, or a region of a human body facing forward can be set as a specific region. In a case where the specific object is an automobile, a region including an entire automobile or a region just including a license plate can be set as the specific region. In the present exemplary embodiment, the specific region will be described as a human body region detected by the human body detection unit 303.

The blurring processing for blurring the specific region can include abstraction processing such as silhouetting processing, mosaic processing, or shading processing, and mask processing. In the silhouetting processing, the specific region can be filled with a predetermined uniform color, or the specific region can be brought into a translucent state by combining an image of a background (background image) previously acquired with the specific region at a predetermined ratio. In the present exemplary embodiment, translucent processing for making the specific region translucent using a background image is employed as the image processing (blurring processing).

Here, a background image refers to an image including only a background without objects, and the background image is stored in the image storage unit 305 (see Image-D in FIG. 4). The image processing unit 304 sets the human body region detected by the human body detection unit 303 as the specific region, and combines the specific region in a captured image with the background image stored in the background image storage unit 305 at a predetermined ratio to generate a combined image (see Image-E in FIG. 4). Next, the image processing unit 304 combines the captured image and the combined image to generate a privacy protection processed image (processed image). Then, the image processing unit 304 outputs the generated processed image to the output control unit 306.

The output control unit 306 outputs the processed image received from the image processing unit 304 to an external output unit such as a display of a display destination or a communication destination for recording or displaying the image. In the present exemplary embodiment, the output control unit 306 outputs the processed image to the information processing apparatus 30. Through the above processing, the information processing apparatus 30 can display the processed image on a display as a display image (see Image-F in FIG. 4).

The protection image processing unit 307 acquires an unprocessed image (original image) of the region specified as the specific region by the image processing unit 304 from the image acquired by the image acquisition unit 301. Then, based on the acquired original image of the specific region, the protection image processing unit 307 outputs a protection image that includes at least a part of the original image of the specific region to the output control unit 306. In the present exemplary embodiment, the protection image processing unit 307 simply outputs the original image of the specific region to the output control unit 306 as the protection image.

At this time, the output control unit 306 outputs the protection image to an output destination on which privacy protection control can be executed. The output destination on which the privacy protection control can be executed can be a storage medium such as a secure digital (SD) card detachably attached to the camera 20.

The privacy protection control prevents the protection image from being seen by an unspecified number of people. In a case where the output destination of the protection image is the SD card detachably attached to the camera 20, privacy protection control can be executed by locking the exterior of the SD card with a physical key, so that only a predetermined administrator can access the SD card. As described above, the output control unit 306 outputs the protection image that is the unprocessed image to the output destination different from the output destination of the processed image.

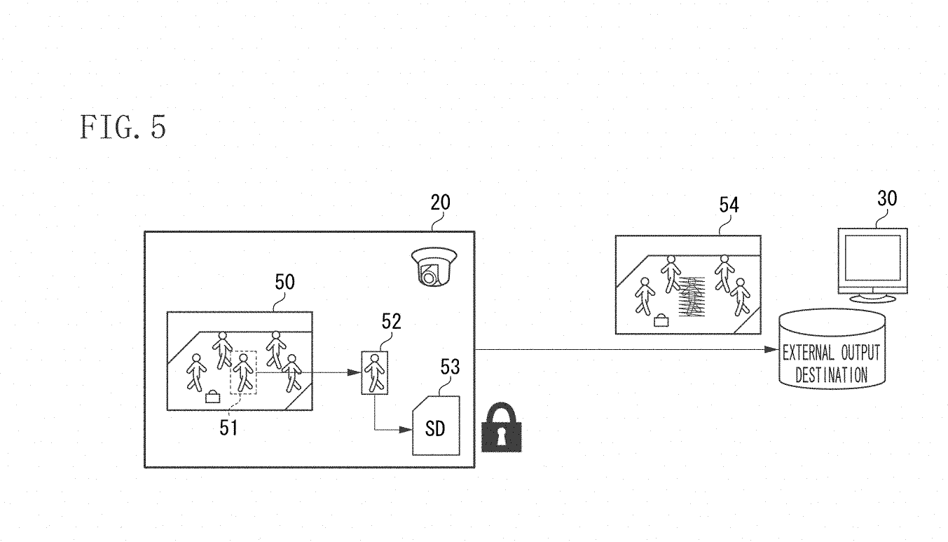

FIG. 5 is a diagram illustrating examples of output destinations of the protection image and the processed image. As described in the present exemplary embodiment, when the camera 20 operates as the image processing apparatus 300, a storage medium 53 such as the SD card attached to the camera 20 can be used as the output destination of the protection image. The information processing apparatus 30 different from the output destination of the protection image can be used as the output destination of the processed image.

For example, it is assumed that a specific region 51 is detected as a target of privacy protection when the image analysis processing is executed on an image 50 captured by the camera 20. In this case, a protection image 52, i.e., an image before image processing for protecting privacy is executed on the specific region 51, is output to the storage medium 53 such as the SD card attached to the camera 20. Then, a processed image 54, i.e., an image after image processing for protecting privacy is executed on the specific region 51, is output to the information processing apparatus 30 that is the external output destination of the camera 20.

As the privacy protection control, the storage medium 53 such as the SD card is locked with a physical key. With this configuration, from the information processing apparatus 30 or another apparatus serving as the output destination of the processed image (privacy protection processed image), only a predetermined administrator can access the image before privacy protection processing. Accordingly, privacy of the object that is a target of privacy protection processing can be appropriately protected.

In addition, any method can be used as the privacy protection control method as long as the method can prevent the protection image from being seen by the unspecified number of people. The output destination of the protection image is not limited to the SD card on which the privacy protection control can be executed. For example, a storage medium provided on the network accessible by only a specific administrator can be used as the output destination of the protection image.

In the present exemplary embodiment, although an exemplary embodiment in which the protection image processing unit 307 simply outputs the original image of the specific region as the protection image has been described, the protection image can be an image including at least a part of the original image of the specific region, and thus the region of the protection image can be an optional image region. In other words, a region of the protection image can be a part of the specific region such as a face region that is a part of the human body region. In addition, a region of the protection image can be a region larger than the specific region, which includes the specific region. The protection image can be an image having an image size the same as that of the captured image, and only a specific region is the original image while the rest of the region in the protection image is filled with black. Alternatively, the protection image can be an image in which a region including at least a specific region is compressed at a compression rate of the original image that is the same as that of the captured image, while the rest of the region is compressed at a compression rate higher than that of the captured image.

The restoration information processing unit 308 generates restoration information that makes the original image (captured image) before image processing be restorable, from the processed image output by the image processing unit 304 and the protection image output by the protection image processing unit 307. Here, the restoration information includes at least association information for associating the processed image with the protection image and position information indicating a position of the protection image in the captured image. Frame numbers of the associated processed image and protection image can be used as the association information. In addition, the association information is not limited to the frame numbers, and time information or another piece of information can be used as long as the processed image and the protection image can be associated with each other.

The restoration information processing unit 308 outputs the generated restoration information to the output control unit 306. At this time, the output control unit 306 outputs the restoration information to the output destination on which privacy protection control can be executed. For example, the output destination the same as that of the protection image can be used as the output destination of the restoration information.

The restoration information can include a decryption key for displaying the protection image. In this case, the protection image is encrypted by the protection image processing unit 307, and the encrypted protection image is stored in the storage medium such as the SD card. With this configuration, the protection image cannot be reproduced unless the decryption key included in the restoration information is used. In other words, privacy protection control of the protection image can be executed by using the decryption key.

When restoration processing of the image is executed, the output processed image and the protection image can be associated with each other by using the association information included in the restoration information. A position where the protection image is embedded in the processed image can be determined by using the position information included in the restoration information. Accordingly, restoration of the original image in which the image processing is not executed on the specific image can be executed based on the restoration information. The restoration processing can be executed by the image processing apparatus 300 as necessary, or can be executed by an apparatus that displays the restored original image. An apparatus that displays the restored original image can be the information processing apparatus 30, another PC, or another device.

In the present exemplary embodiment, while the exemplary embodiment in which the protection image and the restoration information are output to the same output destination has been described, the protection image and the restoration information can be output to different output destinations. Similar to the case of the protection image, any method can be used as the control method of protecting privacy of the output destination of the restoration information as long as the method can prevent the restoration information from being seen by the unspecified number of people. Similarly, the output destination of the restoration information is not limited to the SD card on which privacy protection control can be executed, and for example, a storage medium provided on the network accessible by a specific administrator can be used as the output destination of the restoration information.

An output destination on which privacy protection control cannot be executed can be used as the output destination of the restoration information. While the restoration information is output to the output destination on which privacy protection control can be executed, another piece of restoration information can also be output to an output destination similar to that of the processed image, and whether both pieces of restoration information are applicable can be authenticated by another access management application.

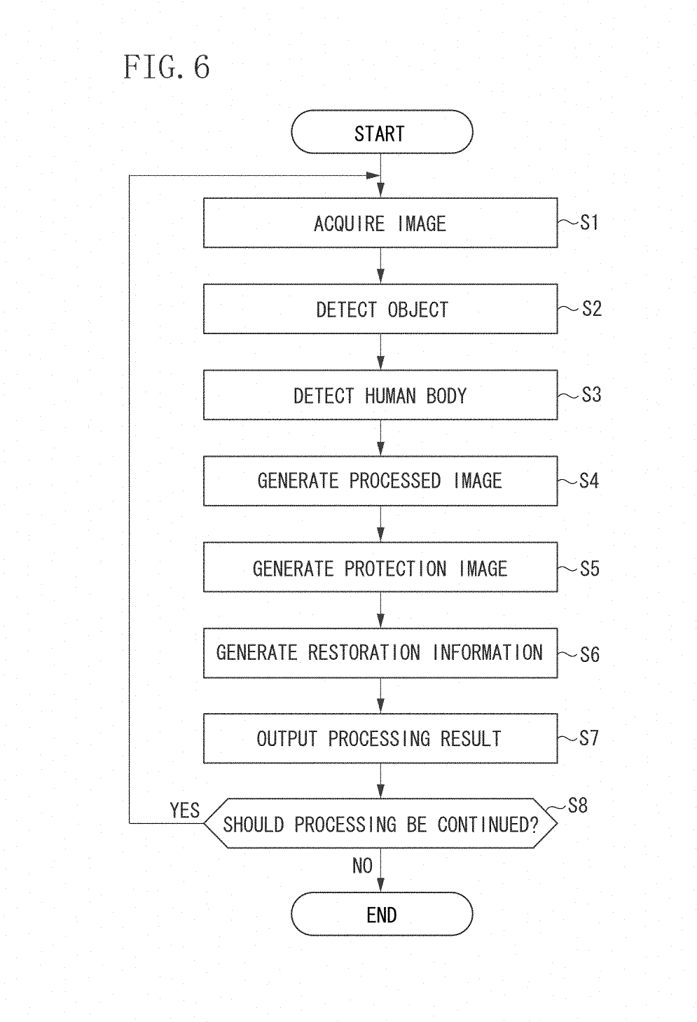

Next, an operation of the image processing apparatus 300 will be described with reference to FIG. 6.

For example, the processing illustrated in FIG. 6 is started at a time when the image processing apparatus 300 acquires the image, and repeatedly executed every time the image is acquired thereby until the user provides an instruction to end the processing. However, a time of starting or ending the processing in FIG. 6 is not limited to the above-described timing.

The image processing apparatus 300 can realize respective processing steps illustrated in FIG. 6 when the CPU 21 reads and executes a necessary program. However, as described above, the processing in FIG. 6 can be realized by at least a part of the elements illustrated in FIG. 3 operating as dedicated hardware. In this case, the dedicated hardware operates based on the control of the CPU 21. Hereinafter, an alphabet “S” represents “step” in the flowchart.

First, in step S1, the image acquisition unit 301 acquires an image, so that the processing proceeds to step S2. In step S2, the object detection unit 302 detects an object in the image based on the image acquired in step S1, and detects an object region that includes the detected object. Next, in step S3, the human body detection unit 303 executes human body detection processing and face detection processing with respect to the object region detected by the object detection processing in step S2.

In step S4, the image processing unit 304 extracts the human body region detected in step S3 as a specific region where privacy protection should be executed, and executes image processing for blurring the specific region in the image. In step S4, the image processing unit 304 combines the image acquired in step S1 and a combined image acquired by combining the specific region of that image with a background image to create a processed image.

In step S5, the protection image processing unit 307 acquires a frame number of the image of a target of the image processing in step S4 and a position of the specific region in the image extracted in step S4, and acquires the unprocessed original image corresponding to the specific region based on the acquired information. Then, the protection image processing unit 307 generates a protection image including at least a part of the original image of the specific region based on the acquired original image of the specific region. In step S5, the protection image processing unit 307 can encrypt the protection image and acquire a decryption key.

In step S6, based on the processed image generated in step S4 and the protection image generated in step S5, the restoration information processing unit 308 generates restoration information that makes the unprocessed original image be restorable. Here, the restoration information includes information about the frame number and the position of the specific region in the image acquired in step S5. The restoration information can include the decryption key acquired in step S5.

In step S7, the output control unit 306 outputs the processed image generated in step S4, the protection image generated in step S5, and the restoration information generated in step S6 to respective predetermined output destinations, and the processing proceeds to step S8. In step S7, the output control unit 306 outputs the processed image generated in step S4 to a display of a display destination or a communication destination for recording or displaying the processed image. In step S7, the output control unit 306 outputs the protection image generated in step S5 and the restoration information generated in step S6 to the SD card arranged in a physical outer package detachably attached to the camera 20.

In step S8, the image processing apparatus 300 determines whether to continue the processing. For example, the image processing apparatus 300 determines whether to continue the processing according to whether an instruction to end the processing is input by the user. Then, if the image processing apparatus 300 determines that the processing should end (NO in step S8), the processing ends. If the image processing apparatus 300 determines that the processing should continue (YES in step S8), the processing returns to step S1.

As described above, the image processing apparatus 300 generates a processed image (first image) in which image processing for protecting privacy is executed on a specific region in an image (captured image). Then, the image processing apparatus 300 outputs the generated processed image to the information processing apparatus 30 (first output destination). The image processing apparatus 300 outputs a protection image (second image) that is an unprocessed image that includes at least a part of the unprocessed image of the specific region, to a second output destination different from the first output destination.

Here, blurring processing for blurring the specific region in the image can be executed as the image processing. The blurring processing includes processing for making a specific object that is a target of privacy protection become unrecognizable, such as silhouetting processing, mosaic processing, shading processing and mask processing, in which a captured image and a background image are combined at a predetermined ratio. In the image processing, the image processing apparatus 300 detects a specific object that is a target of privacy protection in the image and extracts a region of the detected specific object as a specific region. Then, the image processing apparatus 300 executes blurring processing on the extracted specific region. A human body or a face in the image can be specified as the specific object, and a region including the human body or the face in the image can be specified as the specific region.

Through the above processing, the information processing apparatus 30 that receives the processed image can display or record the image in which image processing is executed on the specific region in order to protect privacy of the object that is a target of privacy protection. The image processing apparatus 300 outputs the protection image that includes at least a part of the image of the specific region before executing image processing to the output destination different from the information processing apparatus 30 serving as the output destination of the processed image. Accordingly, the original image can be reproduced as necessary while protecting the privacy of the object that is a target of privacy protection.

In other words, in case of emergency, a specific administrator can appropriately check the unprocessed image of the processed specific region. When a person other than a specific person is to be monitored while image processing for protecting privacy is executed on only the specific person in the image, there is a case where the image processing for protecting privacy is executed on the person that is a monitoring target because of false human detection. In such a case, by making the original image restorable, the unprocessed image of the person that is a monitoring target can be appropriately displayed and monitored.

The image processing apparatus 300 executes privacy protection control for protecting the protection image output to the second output destination. Specifically, the image processing apparatus 300 protects the protection image from being seen by the unspecified number of people by using a physical key, a decryption key, a license, or an access right. As described above, because the image processing apparatus 300 outputs the protection image to the protected output destination, an image including unprotected privacy can be prevented from leaking.

The image processing apparatus 300 outputs restoration information that makes the unprocessed original image be restorable from the protection image and the processed image. Here, the restoration information includes at least association information for associating the processed image with the protection image and position information indicating a position of the specific region in the original image. Accordingly, restoration of the entire original image can be appropriately executed based on the restoration information.

When the camera 20 operates as the image processing apparatus 300, a storage medium such as an SD card attached to the camera 20 can be used as the second output destination for outputting the protection image. With this configuration, the camera 20 internally executes the image processing and internally stores the protection image so that the image that includes unprotected privacy can be prevented from being unnecessarily output to the outside of the camera 20.

The protection image can be a part of the original image. In other words, an image size of the protection image can be smaller than that of the captured image. Therefore, a data size of the protection image can be reduced accordingly. Restoration of the entire original image can be executed by combining the processed image and the protection image output to respective different output destinations. In other words, in order to execute restoration of the entire original image, it is necessary to acquire restoration information for associating and combining the processed image and the protection image.

A compression rate of the region including at least the specific region in the protection image to the captured image can be lower than a compression rate of the rest of the region in the protection image, to the captured image. With this configuration, the unprocessed image of the specific region that is a target of privacy protection can be reproduced with high precision while suppressing the data size of the protection image.

### Variation Example

In the above-described exemplary embodiment, an object or a human body is specified as a target of the image processing. However, in a case where only a human body is specified as a target of the image processing, the image processing apparatus 300 does not have to include the object detection unit 302 in FIG. 3.

In the above-described exemplary embodiment, while the camera 20 operating as a monitoring camera has been described, the camera 20 can be a camera used for broadcasting a video image in a public space. In this case, only an announcer positioned in a specific region (e.g., a center of the screen) can be displayed while image processing such as shading processing is executed on the other objects including a human body.

### Other Exemplary Embodiments

One or more of the functions of the above-described exemplary embodiments can be realized by a program supplied to a system or an apparatus via a network or a storage medium, so that one or more processors in the system or the apparatus reads and executes the program. The one of more functions can also be realized with a circuit (e.g., application specific integrated circuit (ASIC)) that realizes one or more functions.

In recent years, because there has been provided a network camera having an add-on function for adding functions, functions described in the above exemplary embodiment can be detachably attached by using the add-on function. For example, if the privacy protection function described in the above exemplary embodiment is added to a network camera that does not have a normal privacy protection function, by using the add-on function, a video image processed by the privacy protection processing is distributed in place of a normal video stream distributed to the network.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-175223, filed Sep. 8, 2016, which is hereby incorporated by reference herein in its entirety.

What is claimed is:

1. An image processing apparatus comprising:
a processing unit configured to generate a first image in which blurring processing for protecting privacy is executed with respect to a specific region in an image specified by image analysis;
a first output unit configured to output the first image generated by the processing unit to a first output destination; and
a second output unit configured to output a second image including at least a part of an image of the specific region before the blurring processing is executed by the processing unit to a second output destination different from the first output destination.

2. The image processing apparatus according to claim 1 further comprising a protection control unit configured to protect the second image output by the second output unit.

3. The image processing apparatus according to claim further comprising a third output unit configured to output restoration information that makes the image before executing the blurring processing be restorable from the first image and the second image.

4. The image processing apparatus according to claim 3, wherein the restoration information includes at least association information that associates the first image with the second image and position information that indicates a position of the second image in the image.

5. The image processing apparatus according to claim 1 further comprising a storage unit configured to serve as the second output destination.

6. The image processing apparatus according to claim 1, wherein a compression rate of a region including the specific region in the second image is lower than a compression rate of another region in the second image.

7. The image processing apparatus according to claim 1, wherein the processing unit is further configured to detect a specific object in the image and extract a region of the detected specific object as the specific region.

8. The image processing apparatus according to claim 1, wherein the specific region is a region including a human body.

9. The image processing apparatus according to claim 1 further comprising an expansion unit configured to expand a function of the image processing apparatus,
wherein blurring processing for protecting privacy is a function expanded by the expansion unit.

10. An image processing method comprising:
generating a first image in which blurring processing for protecting privacy is executed with respect to a specific region in an image specified by image analysis;
outputting the first image to a first output destination; and
outputting a second image including at least a part of an image of the specific region before executing the blurring processing to a second output destination different from the first output destination.

11. A computer-readable storage medium storing a program that causes a computer to execute a method, the method comprising:
generating a first image in which blurring processing for protecting privacy is executed with respect to a specific region in an image specified by image analysis;
outputting the first image to a first output destination; and
outputting a second image including at least a part of an image of the specific region before executing the blurring processing to a second output destination different from the first output destination.
